(19) United States
(12) Patent Application Publication
(10) Pub. No.: US 2013/0265236 A1
(43) Pub. Date: Oct. 10, 2013

(54) SYSTEM AND METHOD FOR INPUTTING CHARACTERS TO A DISPLAY DEVICE VIA A REMOTE CONTROL DEVICE

(71) Applicant: SAMSUNG ELECTRONICS CO., LTD., Gyeonggi-do (KR)

(72) Inventor: Yonggeol JUNG, Gyeonggi-do (KR)

(73) Assignee: Samsung Electronics Co., Ltd., Gyeonggi-do (KR)

(21) Appl. No.: 13/856,674

(22) Filed: Apr. 4, 2013

(30) Foreign Application Priority Data
Apr. 5, 2012 (KR) 10-2012-0035578

(51) Int. Cl. G06F 3/023

(52) U.S. Cl. CPC G06F 3/023
USPC 345/169

(57) ABSTRACT

A system and method for inputting characters to a display device via a remote control device includes units for inputting one or more characters via one key. The character input system and method reduces the number of times that the user inputs characters and allows users to input the same character successively without wait time. The character input method includes operating a numeric key in a character key zone, selecting a group of characters allocated to the operated numeric key, operating a shortcut key in a shortcut key zone, and inputting a character included in the group of characters, corresponding to the shortcut key.

### PRIORITY

This application claims priority under 35 U.S.C. §119(a) to a Korean patent application filed on Apr. 5, 2012 in the Korean Intellectual Property Office and assigned Serial No. 10-2012-0035578, the entire disclosure of which is incorporated herein by reference.

### BACKGROUND

1. Field of the Invention

The present invention relates generally to a system and method for user input and more particularly a system and method for quick and easy character input on a display device, via a remote control device.

2. Description of the Related Art

Display devices refer to electronic systems capable of recording videos on recording media and playing back the recorded videos or videos transmitted from external devices. With rapid development in image processing technologies and broadcasting technologies, display devices provide various types of content. Specifically, with the creation of digital televisions and Internet televisions as display devices, users can view a variety of content via a television. This requires users to search for a corresponding item of content by inputting numbers or characters to the display devices.

Conventional character input systems use wired/wireless keyboards or remote control devices with character keys in order to input characters to display devices such as televisions. However, these conventional systems are disadvantageous because they must be equipped with keyboards for televisions which increases the manufacturing costs. In addition, users are required to install a separate keyboard to the television in order to input characters to a television while watching the television, which is inconvenient.

Conventional television remote control devices are equipped only with numeric keys, i.e., without alphabetic keys. Numeric keys are used to select a channel number and to input information as well. Conventional remote control devices are also manufactured to be small in size, with a limited space for keys for inputting characters. Therefore, one numeric key is used to input a character, including lowercase and uppercase characters, punctuation characters, numbers, and special characters, as well as the allocated number. Numeric keys of the conventional remote control device are allocated with specific groups of characters per key (e.g., a preset number of characters and other characters), and are used to input numbers and characters.

Conventional remote control devices are designed in such a way that each numeric key is allocated with a number of keys and respective numeric keys have different arrangements of characters depending on the manufacturers. Therefore, when a user inputs characters allocated in the same numeric key to a display device, via a remote control device, from the second character onward, the user is required to repeat an input by a number of times corresponding to the order number of the respective character allocated to the same numeric key. After inputting a first character allocated to the same numeric key, in order to successively input the same character again, the user is required to wait a predetermined period of time before inputting the next same character, or move a cursor to the next input position, by using another key, for example a navigation key, after inputting the first character and only then inputting the next same character.

The delay in inputting characters and the increased number of key operations in conventional character input systems makes user input time-consuming and inconvenient. Additionally, while a user is inputting characters to a television via the character keys of a remote control device, the user cannot see the remote control device and the television at the same time. Therefore, the user first views and inputs a character key on the remote control device, in order to input a corresponding character and then views the television screen to confirm that the correct character is input, which slows down user input and inconveniences the user.

### SUMMARY

Accordingly, the present invention has been made in view of the above problems and/or disadvantages, and the present invention provides a character input system and method that allows users to easily input instructions to a display device, via a remote control device.

An aspect of the present invention provides a character input system and method that allows users to easily and precisely input instructions, such as characters, to a display device, via a remote control device, with a small number of input operations.

An aspect of the present invention provides a character input system and method that allows users to input characters allocated to respective keys of a remote control device, with a higher efficiency when repeatedly inputting characters from the highest character to the lowest character.

An aspect of the present invention provides a character input system and method that allows users to easily and rapidly input characters in group, allocated to a key of a remote control device, to a display device, irrespective of the order of characters, via a remote control device.

An aspect of the present invention provides a character input system and method that enhances the use and convenience of a remote control device and a display device, by achieving an environment where characters are input to display devices via remote control devices.

In accordance with an embodiment of the present invention, there is provided a character input method for inputting characters via a remote control device, including operating a numeric key in a character key zone, selecting a group of characters allocated to the operated numeric key, operating a shortcut key in a shortcut key zone, and inputting a character included in the group of characters, corresponding to the shortcut key.

In accordance with another embodiment of the present invention, there is provided a character input system including a remote control device and a display device. The remote control device creates instructions according to a user's inputs, and inputs characters via numeric keys in a character key zone and shortcut keys in a shortcut key zone, corresponding the numeric keys with the shortcut keys. The display device displays screens and character input states according to the control of the remote control device.

In accordance with another embodiment of the present invention, there is provided a computer readable medium storing a program that transmits, to a display device, user instructions for selecting, when a numeric key is operated in a character key zone of a remote control device, a group of characters allocated to the numeric key, and inputting, when a shortcut key is operated in a shortcut key zone of the remote control device, a character included in the group of characters corresponding to the operated shortcut key.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a configuration of a character input system, according to an embodiment of the present invention;

FIG. 2 is a diagram illustrating an external appearance of a remote control device for supporting a character input function, according to an embodiment of the present invention;

FIG. 3 is a block diagram illustrating a remote control device, for supporting a character input function, according to an embodiment of the present invention;

FIGS. 4 and 5 are diagrams illustrating a process for inputting characters via a remote control device, according to an embodiment of the present invention;

FIG. 6 is a flow chart for a method for inputting characters via a remote control device, according to an embodiment of the present invention; and

FIGS. 7 to 9 are flow charts for a method for controlling a remote control device to perform a character input process, according to an embodiment of the present invention.

### DETAILED DESCRIPTION OF THE EMBODIMENTS OF THE PRESENT INVENTION

Hereinafter, various embodiments of the present invention are described in detail with reference to the accompanying drawings. The same reference numerals are used throughout the drawings to refer to the same or similar components. Detailed descriptions of well-known functions and structures are omitted to avoid obscuring the subject matter of the present invention.

The present invention relates to a system and method that allows users to input characters (e.g., numeric characters, letter characters of a language, Korean characters, English uppercase and lower characters, special characters, etc.) to a display device via a remote control device. The remote control device, adapted to the character input system and method, is equipped with an input unit that allows a user to input one or more characters via one key. The remote control device reduces the number of times a user inputs a character and also a user's waiting time for inputting characters, specifically, in cases when the same characters are successively input, thereby providing a rapid character-input function.

The remote control device according to an embodiment of the present invention is designed in such a way that the components for inputting characters are divided into a shortcut key area and a character key area. The remote control device reduces the number of key presses to input characters and the overall period of time to input characters. Additionally, the remote control device, according to an embodiment of the present invention, minimizes failure in inputting a character, by using the shortcut key area and the character key area. Specifically, the character key area includes a number of keys for each of which a number of characters are allocated to. When the user inputs characters, grouped and allocated to respective keys, from the highest order of character to the lowest order of character, the remote control device allows the user to directly input a character in a group of characters, irrespective of the arrangement order, via a key in the shortcut area.

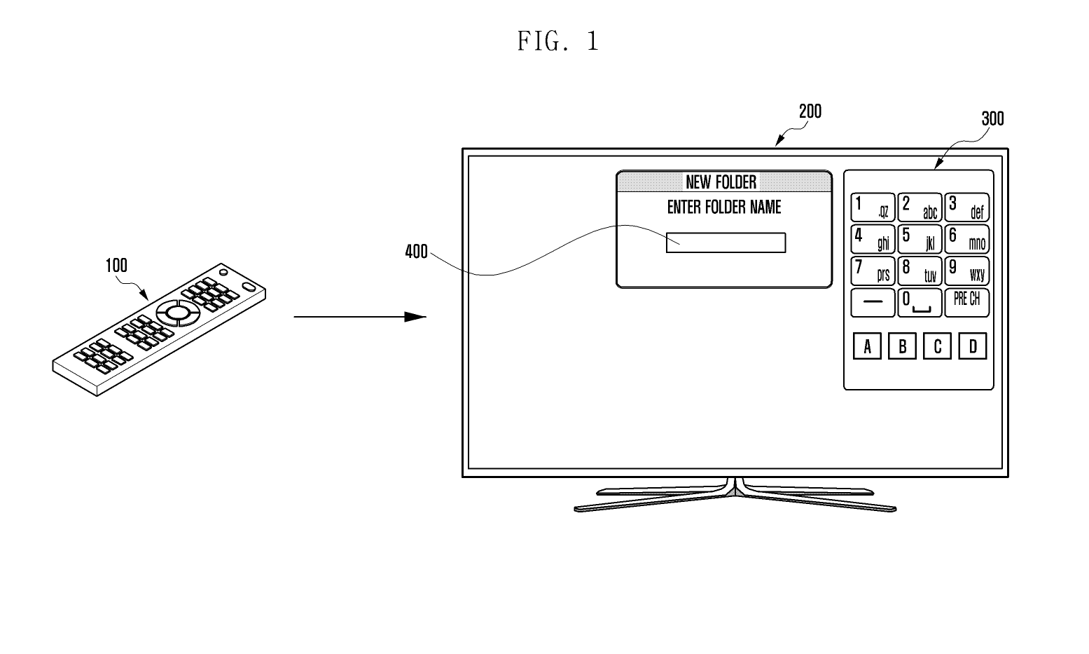

FIG. 1 is a diagram illustrating a configuration of a character input system according to an embodiment of the present invention.

Referring to FIG. 1, the character input system includes a remote control device 100 and a display device 200.

The remote control device 100 detects a key selected by a user, creates a user instruction corresponding to the selected key, and transmits it to the display device 200. Examples of user instructions include a command for turning on or off the display device 200, commands for controlling the functions of the display device 200 turned on, a command for inputting characters to the display device 200 turned on, etc. A detailed description of the remote control device 100 is provided below with reference to the accompanying drawings.

The display device 200 plays back content, transmitted from external systems (e.g., a broadcasting server, an Internet server, etc.), or stored content (e.g., audio contents, video contents, etc.) and displays the content. The display device 200 includes a display module (not shown) for displaying video content and an audio module (not shown) for outputting audio content. The display module displays video content on a display panel of various types, including Liquid Crystal Display (LCD), Plasma Display Panel (PDP), Electro Luminescent Display (ELD), Vacuum Fluorescent Display (VFD), and the like. The audio output module is implemented with internal speakers or loudspeakers.

The display device 200 includes a tuner (not shown). The display device 200 receives signals related to contents (e.g., broadcasts) via the tuner, converts them to playback data, and outputs it. For example, if the display device 200 is a digital TV, it receives a digital broadcast and outputs the video signals and the audio signals. Digital broadcasting carries broadcasts created by compressing video data and audio data.

The display device 200 includes a network interface for connecting to a network. The display device 200 is allocated with an Internet Protocol (IP) address and processes data packets transmitted from the network. The data packets include video data and audio data related to contents to be played back.

The display device 200 receives user instructions transmitted from the remote control device 100 and executes the functions corresponding thereto. For example, user instructions are setting a screen display environment, switching the current display screen to other screens, displaying a screen interface, corresponding to the character input configuration of the remote control device 100 (which is called a character input interface 300), on the currently displayed screen.

When the user inputs characters to the display device 200 via the remote control device 100, the character input system synchronizes the character input interface 300 with the currently displayed screen of the display device 200.

The display device 200 may display the character input interface 300, superimposed on the currently displayed screen. Alternatively, the display device 200 may display the character input interface 300 on one of the divided screen areas. To this end, the display device 200 rearranges the currently displayed screen by pushing it to one side of the screen as if the screen area is divided into two sub-screen areas and displays it on one of the sub-screen area and the character input interface 300 on the other sub-screen area. The display device 200 synchronizes a user's operations of the remote control device 100 with the character input interface 300. Next, the display device 200 displays the information (e.g., a user's input key area, a character corresponding to the input key, etc.) corresponding to a user's input instruction on the character input interface 300 and on a character display field 400 according to a type of content to be displayed.

For example, if the user selects a numeric key ‘1’ on the remote control device 100, the display device 200 may display a visual effect (highlighting, a shade effect, an embossing effect, blinking, etc.) on the button corresponding to the key ‘1’ on the character input interface 300. Alternatively, the display device 200 may display a mode for inputting characters allocated to the numeric key ‘1’ in a preset character mode (e.g., a Hangeul (Korean) mode, a Numeric mode, an English Mode, etc.) and a character, corresponding to the number of times the user made inputs, on the character display field 400.

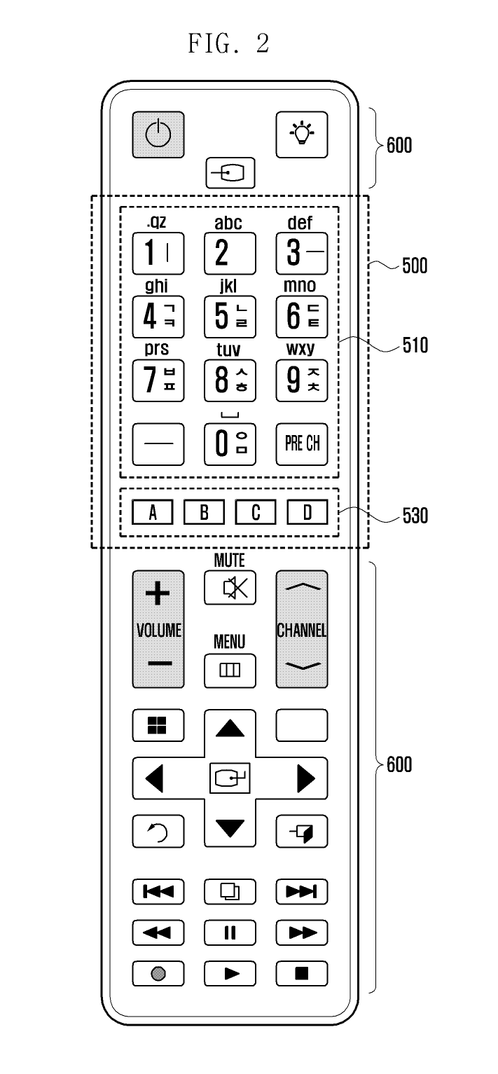

FIG. 2 is a diagram illustrating an external appearance of a remote control device 100 for supporting a character input function according to an embodiment of the present invention.

Referring to FIG. 2, the remote control device 100 is designed in such a way that the area is divided into a character input region 500 and an instruction input region 600. The character input region 500 refers to a portion where keys for supporting a character input function is located when characters are input to the display device 200 via the remote control device 100. The instruction input region 600 refers to a portion where keys allocated with a variety of instructions for controlling the functions of the display device 200 are located.

The character input region 500 includes a character key zone 510 and a shortcut key zone 530, where physical keys are located respectively.

The character key zone 510 includes numeric keys used to execute a variety of functions, e.g., a function for selecting channel numbers to display content on the display device 200. The numeric keys of the character key zone 510 are also allocated with one or more characters, respectively. That is, the numeric keys of the character key zone 510 are also allocated with groups of characters (e.g., groups of Korean characters, groups of English characters, etc.), respectively. Therefore, a user inputs numbers, his/her own language characters (e.g., Hangeul or Korean, English lowercase or uppercase characters, etc.), special characters, etc.), etc., via each of numeric keys of the character key zone 510. As such, the character key zone 510 is designed in such a way that respective keys are allocated with a number of characters. The arrangements of keys in the character input region 500 and the instruction input region 600 differ from each other, according to types of remote control devices and the manufacturers.

The shortcut key zone 530 may provide different functions between when the display device 200 operates in a function control mode and in a character input mode. That is, when the display device 200 operates in a function control mode, the keys in the shortcut key zone 530 provide the originally allocated functions respectively. Conversely, when the display device 200 operates in a character input mode, the keys in the shortcut key zone 530 serve as keys for supporting a character input function to rapidly switch characters allocated to respective keys of the character key zone 510 while the characters are input.

The keys in the shortcut key zone 530 support functions when the user rapidly inputs characters grouped and allocated to the respective keys of the character key zone 510 in a character input mode of the display device 200. That is, the keys of the shortcut key zone 530 support a character input function by rapidly switching between characters grouped and allocated to the respective keys of the character key zone 510. The shortcut key zone 530 is configured via the keys of the remote control device 100. Although the shortcut key zone 530 includes four keys (e.g., A, B, C, and D) as illustrated in FIG. 2, alternatively, the configuration is not limited thereto. The shortcut key zone 530 is operated according to the maximum number of characters allocated to the respective keys of the character key zone 510. Specifically, the remote control device 100 according to the present invention allows a user to directly input any of the characters allocated to the keys of the shortcut key zone 530, irrespective of the arrangement order.

Although the shortcut key zone 530 illustrated in FIG. 2 is located lower than the character key zone 510, alternatively, for example, the shortcut key zone 530 may be located higher than the character key zone 510, or on the right or left of the character key zone 510. Additionally, the shortcut key zone 530 may be located on the side of the remote control device 100. The location and arrangement of the shortcut key zone 530 and the character key zone 510 are set during manufacturing of the remote control device 100, in a way that the user can easily operate the remote control device 100.

Inputting characters to the display device 200 via the remote control device 100 is executed in a normal input mode or in a shortcut input mode. In a normal input mode, the user inputs characters, via only the keys of the character key zone 510, in a character input mode provided by the remote control device 100. In a shortcut input mode, the user inputs characters, via the keys of the character key zone 510 and the shortcut key zone 530.

Normal input mode refers to a mode where a user inputs one of a number characters, allocated to a key of the character key zone 510, by repeatedly operating the key until the character appears on the screen of the display device 200.

Shortcut input mode refers to a mode where a user inputs one of a number of characters, allocated to a key of the character key zone 510, by operating one of the shortcut keys of the shortcut key zone 530 that corresponds to the order of the character in the key, resulting in a direct input of the intended character. That is, in a shortcut input mode, the user first selects a key allocated with a character to be input in the character key zone 510, and then a shortcut key of the shortcut key zone 530 corresponding to the order where the character is located in the group of characters allocated to the character key of the character key zone 510, thereby rapidly inputting the character.

In a shortcut input mode, the user first selects a group of characters including a character that the user wants to input via a numeric key in the character key zone 510, and then a shortcut key of the shortcut key zone 530 corresponding to the order where the character is located in the group of characters, thereby rapidly inputting the character. For example, if a user wants to input the character ‘o,’ the user first selects a group of characters {m, n, o} including the character ‘o’ via the numeric key ‘6’ in the character key zone 510. Since the character ‘o’ is located at the third place of the group of characters {m, n, o}, the user selects the third shortcut key ‘C’ of the shortcut key zone 530, thereby rapidly inputting the character ‘o.’ Next, if the user needs to successively input the same character ‘o,’ since the key with the group of characters containing the character ‘o’ has been selected, the user operates only the shortcut key ‘C’ once again, thereby rapidly inputting the character ‘o.’

A detailed description regarding the operations of the keys in the character key zone 510 and the shortcut key zone 530, corresponding with each other, is described below.

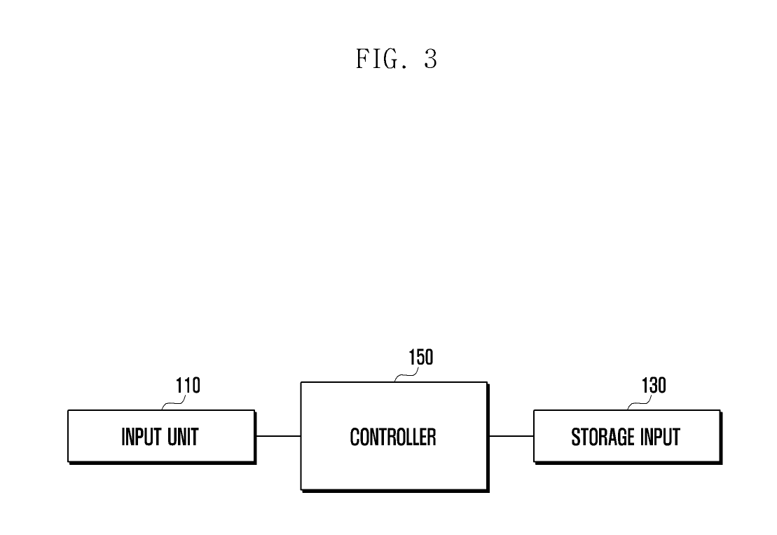

FIG. 3 is a block diagram illustrating a remote control device 100 for supporting a character input function according to an embodiment of the present invention.

Referring to FIG. 3, the remote control device 100 includes an input unit 110, a storage unit 130, and a controller 150.

The input unit 110 receives user inputs, creates the input signals, and transfers them to the controller 150. Examples of user inputs are related to signals for inputting numbers and letters, signals for setting the functions of the display device 200, signals for controlling the functions (e.g., turning on/off the display device 200, switching channels, controlling volume, selecting items of content, etc.). The input unit 110 includes the character input region 500 and the instruction input region 600 as described above. The character input region 500 has a number of keys that are arrayed according to a preset arrangement. The character input region 500 is divided into a character key zone 510 and a shortcut key zone 530. The keys in the character key zone 510 are allocated with groups of characters respectively and support a normal input mode. The keys (shortcut keys) in the shortcut key zone 530 allow the keys of the character key zone 510 to rapidly input a corresponding character in a shortcut input mode.

The storage unit 130 stores programs that the controller 150 uses to execute process and control functions. The storage unit 130 may buffer input/output data (e.g., function control commands, commands related to signals for inputting characters, etc.). Specifically, when the remote control device 100 operates in a character input mode, the storage unit 130 stores data corresponding to a group of characters allocated to a key selected in the character key zone 510. That is, the storage unit 130 buffers data created during the character input mode, by a preset size. The storage unit 130 may be implemented with various types of storage media, e.g., flash memory, hard disk, card type of memory (e.g., SD, XD, etc.), Random Access Memory (RAM), Static Random Access Memory (SRAM), Read-Only Memory (ROM), Electrically Erase Programmable Read-Only Memory (EEPROM), Programmable Read-Only Memory (PROM), etc.

The controller 150 controls the entire operation of the remote control device 100. The controller 150 controls the character input-related processes according to a normal input mode and a shortcut input mode when the remote control device 100 operates in a character input mode.

The controller 150 detects a user's input to a key in the character key zone 510 in a character input mode and identifies the group of characters allocated to the detected key. The controller 150 detects a user's input to a shortcut key in the shortcut key zone 530 and determines, as an input character, one of the characters in group, allocated to the detected key of the character key zone 510, corresponding to the order of detected shortcut key. Next, the controller 150 creates a character code for the determined character and transmits it to the display device 200. The display device 200 displays the character corresponding to the character code transmitted from the remote control device 100.

A detailed operation of the controller 150 is described in detail below referring to the accompanying drawings. The controller 150 controls basic device functions as well as the functions related to the remote control device 100 according to an embodiment of the present invention.

The remote control device 100 according to an embodiment of the present invention, as illustrated in FIG. 3 may further include an RF communication unit for performing communication with the display device 200 in wireless mode, and a power supply for supplying electric power to the components under the control of the controller 150.

Although the keys of the remote control device 100 according to an embodiment of the present invention are implemented as physical types of keys, alternatively, the keys of the remote control device 100 may also be implemented with touch-based input devices, e.g., a touch film, a touch sheet, a touch pad, a touch screen, and the like.

The input system and method, according to an embodiment of the present invention can be implemented as hardware, software, firmware or a combination thereof, recorded in recording media readable via computers or the equivalent devices. The system and method may be implemented in hardware, by using one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro-processors, electrical units for executing functions, etc. Alternatively, the embodiments according to the present invention may be implemented in such a way that the controller 150 executes corresponding functions. The system and method may be implemented in software, by using additional software modules each of which can execute one or more functions that are explained in this description.

The remote control device 100 according to the present invention as illustrated in FIG. 3 can be applied to all information communication devices, multimedia devices, and their applications, such as Application Processors (APs), Graphics Processing Units (GPUs), Central Processing Units (CPUs), etc. For example, embodiments of the present invention can be applied to mobile communication devices which are operated according to communication protocols corresponding to various types of communication systems. The present invention can also be applied to tablet personal computers, smartphones, digital cameras, Portable Multimedia Players (PMPs), multimedia players, mobile game players, laptop computers, Personal Digital Assistants (PDAs), etc.

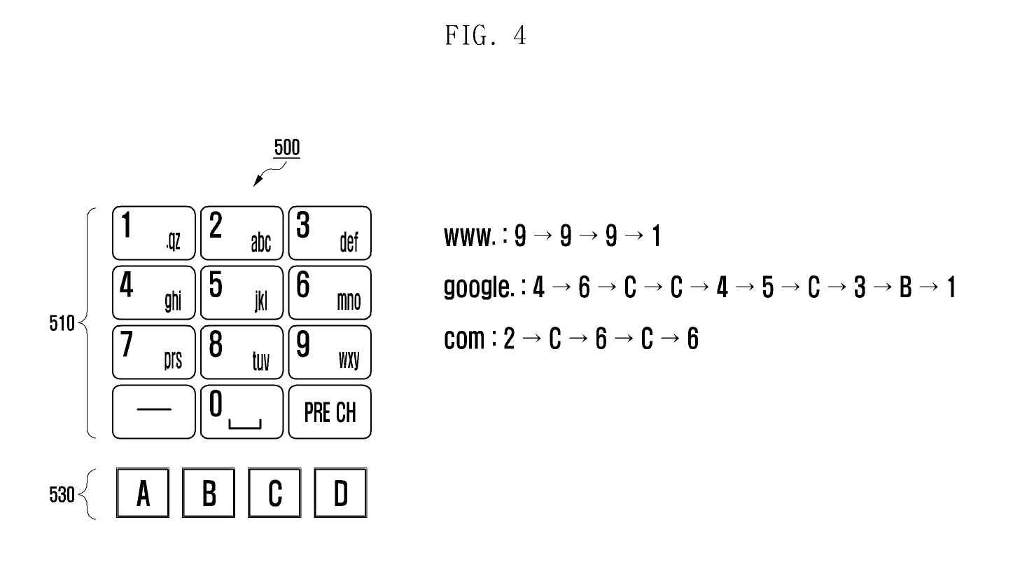

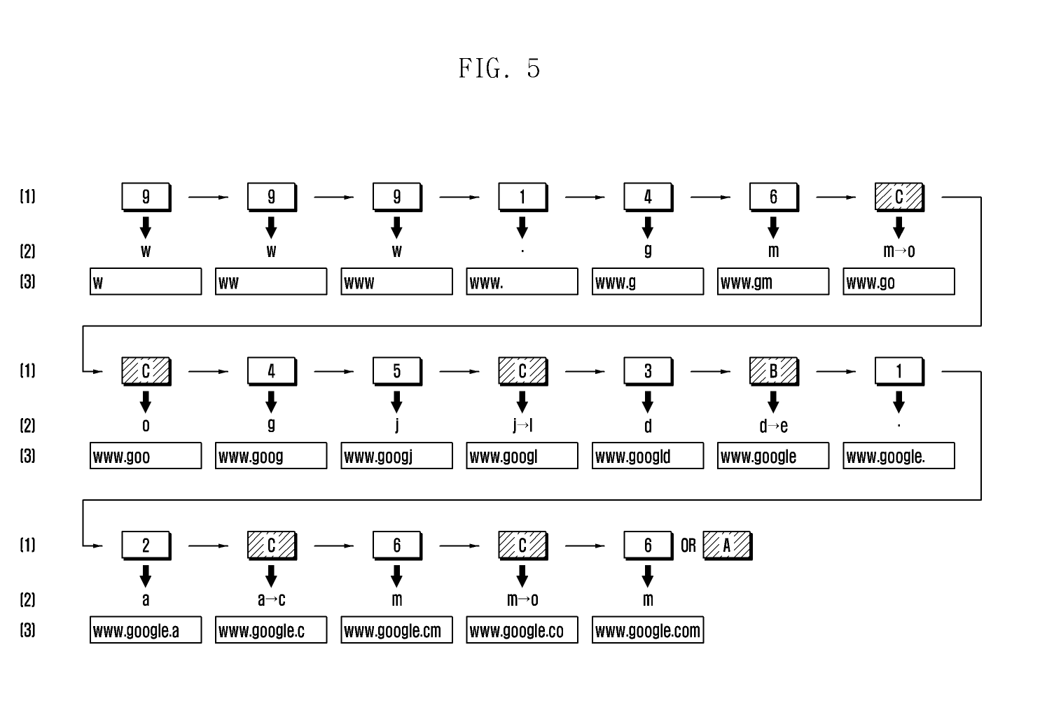

FIGS. 4 and 5 are diagrams illustrating a process for inputting characters via a remote control device according to an embodiment of the present invention.

FIG. 4 illustrates the character input region 500 of the remote control device 100 including the character key zone 510 and the shortcut key zone 530. FIG. 5 illustrates the keys and the character display field describing the process for inputting corresponding characters when the user operates the keys in the character input region 500. Referring to FIG. 5, the first row indicated by reference number (1) shows numeric keys and shortcut keys that the user selects to input corresponding characters, the second row indicated by reference number (2) shows characters selected by operating the keys in the character key zone 510 and by operating the shortcut keys in the shortcut key zone 530, and the third row, indicated by reference number (3), refers to characters (or a string) input by operating the keys in the character key zone 510 and the shortcut key zone 530. In the first row (1), the shaded keys refer to shortcut keys in the shortcut key zone 530.

An embodiment of the present invention is described based on an example where the string ‘www.google.com’ is input by operating the keys in the character key zone 510 and the shortcut key zone 530. When the remote control device 100 enters a character input mode, corresponding with the display device 200, it can automatically support a character input function in a shortcut input mode. A normal input mode and/or a shortcut input mode may be previously set to the remote control device 100 according to a user's setting. Although the process illustrated in FIGS. 4 and 5 is implemented by displaying a blinking character and then switching to a character corresponding to the order of the selected shortcut key, alternatively, displaying the blinking may be skipped. According to an embodiment of the present invention, the blinking character refers to a character, from among the group of characters allocated to a numeric key that has been selected in the character key zone 510, which is in a state before it is used to form a completion character. Displaying the blinking character may be executed or skipped depending on the settings. According to an embodiment of the present invention, the blinking character is processed as a representative character in a group of characters.

Referring to FIGS. 4 and 5, in order to input the character ‘w,’ the user selects the numeric key, ‘9,’ allocated with a group of characters containing the character ‘w,’ in the character key zone 510. The display device 200 displays ‘w’ on the character display field 400. When the numeric key allocated with the character ‘w’ is selected in the remote control device 100, the character input interface 300 of the display device 200 provides a visual effect to the area corresponding to the numeric key ‘9’ (e.g., the button ‘9’ in the character input interface 300 illustrated in FIG. 1).

In order to complete the string ‘www,’ the user can successively operate the numeric key ‘9’ more than twice. In that case, the string ‘www’ is displayed on the character display field 400 of the display device 200. Each time that the user makes an input operation in the remote control device 100, the display device 200 provides a visual effect on the button on the character input interface 300, corresponding to the user's operated key. This may be achieved by an operation described below. If a group of characters is selected via a numeric key in the same way as described above, the character at the first order of the characters in the group is automatically selected and input.

Next, in order to input the symbol ‘.’, the user operates the numeric key ‘1’ allocated with a group of characters containing the symbol ‘.’ in the character key zone 510, thereby completing the string ‘www.’ In that case, the display device 200 displays the string ‘www.’ on the character display field 400.

Next, in order to input the character ‘g,’ the user operates the numeric key ‘4’ allocated with a group of characters containing the character ‘g’ in the character key zone 510. In that case, the display device 200 displays the string ‘www.g’ on the character display field 400.

Next, in order to input the character ‘o,’ the user operates the numeric key ‘6’ allocated with a group of characters containing the character ‘o’ in the character key zone 510 and thus selects the group. Next, the user selects the third shortcut key ‘C’ in the shortcut key zone 530, corresponding to at the third order of the characters in the group of the numeric key ‘6.’ In that case, the display device 200 first displays the string ‘www.gm’ according to the operation of the numeric key ‘6’ on the character display field 400, and then change the character ‘m’ to ‘o’ according to the successive operation of the third shortcut key ‘C,’ thereby displaying the string ‘www.go’ on the character display field 400.

In order to repeatedly input the character ‘o,’ the user may re-select the third shortcut key ‘C’ in the shortcut key zone 530. That is, after inputting the character ‘o’ in such a way that the user: selects a group of characters ‘m,’ ‘n,’ and ‘o’ by operating the key in the character key zone 510; selects the third shortcut key ‘C’ in the shortcut key zone 530, corresponding to the third order of the character ‘o’ in the group of characters; and inputs the character ‘o,’ if the user needs to successively input the character ‘o,’ the user can directly input the character ‘o’ by operating the shortcut key ‘C’ once. This is because the group of characters containing the character ‘o’ has been selected via the earlier key operation. In a state where a numeric key allocated with a group of characters has been selected in the character key zone 510, if shortcut keys are operated in the shortcut key zone 530, corresponding characters can be directly input. For example, in a state where a numeric key allocated with a group of characters ‘m,’ ‘n,’ and ‘o’ has been selected in the character key zone 510, if the shortcut keys ‘C,’ ‘A,’ and ‘B’ are successively operated, the corresponding characters ‘o,’ ‘m,’ and ‘n’ are also successively selected, thereby displaying the string ‘omn’ on the character display field 400 of the display device 200. Therefore, the display device 200 displays the string ‘www.goo’ on the character display field 400, according to the user's input operations in order.

Next, in order to input the character ‘g,’ the user operates the numeric key ‘4’ allocated with a group of characters containing the character ‘g’ in the character key zone 510. In that case, the display device 200 displays the string ‘www.goog’ on the character display field 400.

Next, in order to input the character ‘I,’ the user operates the numeric key ‘5’ allocated with a group of characters containing the character ‘l’ in the character key zone 510 and thus selects the group. Next, the user selects the third shortcut key ‘C’ in the shortcut key zone 530, corresponding to at the third order of the characters in the group of the numeric key ‘5.’ In that case, the display device 200 first displays the string ‘www.googl’ according to the operation of the numeric key ‘5’ on the character display field 400, and then change the character ‘j’ to ‘l’ according to the successive operation of the third shortcut key ‘C,’ thereby displaying the string ‘www.googl’ on the character display field 400.

Next, in order to input the character ‘e,’ the user operates the numeric key ‘3’ allocated with a group of characters containing the character ‘e’ in the character key zone 510 and thus selects the group. Next, the user selects the second shortcut key ‘B’ in the shortcut key zone 530, corresponding to at the second order of the characters in the group of the numeric key ‘3.’ In that case, the display device 200 first displays the string ‘www.googld’ according to the operation of the numeric key ‘3’ on the character display field 400, and then change the character ‘d’ to ‘e’ according to the successive operation of the second shortcut key ‘B,’ thereby displaying the string ‘www.google’ on the character display field 400.

Next, in order to input the symbol ‘.’, the user operates the numeric key ‘1’ allocated with a group of characters containing the symbol ‘.’ in the character key zone 510, thereby completing the string ‘www.google.’ In that case, the display device 200 displays the string ‘www.google.’ on the character display field 400.

Next, in order to input the character ‘c,’ the user operates the keys as described above. That is, the user operates the numeric key ‘2’ allocated with a group of characters containing the character ‘c’ in the character key zone 510 and thus selects the group. Next, the user selects the third shortcut key ‘C’ in the shortcut key zone 530, corresponding to at the third order of the characters in the group of the numeric key ‘2.’ In that case, the display device 200 displays the string ‘www.google.c’ according to the operation of the numeric key ‘2’ on the character display field 400.

Next, in order to input the character ‘o,’ the user operates the keys as described above. That is, the user operates the numeric key ‘6’ allocated with a group of characters containing the character ‘o’ in the character key zone 510 and thus selects the group. Next, the user selects the third shortcut key ‘C’ in the shortcut key zone 530, corresponding to at the third order of the characters in the group of the numeric key ‘6.’ In that case, the display device 200 displays the string ‘www.google.co’ according to the operation of the numeric key ‘6’ on the character display field 400.

Next, in order to input the character ‘m,’ the user operates the numeric key ‘6’ allocated with a group of characters containing the character ‘m’ in the character key zone 510 and thus completes the string ‘www.google.com’. Alternatively, if the user needs to input the character ‘m’, since the group of characters containing the character ‘m’ has been selected at the earlier step, the user can complete the string ‘www.google.com’ by operating the first shortcut key ‘A’ at the first order of the characters in the group. In that case, the display device 200 displays the string ‘www.google.com’ on the character display field 400.

As described above, if a user needs to input ‘www.google.com’, the system and method according to the present invention, allows the user to operate the keys 19 times in total as follows ‘9->9->9->1->4->6->C->C->4->5->C->3->B->1->2->C->6->C->6’. Conversely, conventional systems allow users to operate the keys 25 times in total for as follows ‘9->wait->9->wait->9->1->4->6->6->6->wait->6->6->6->4->5->5->5->3->3->1->2->2->2->6->6->6->wait->6’. Specifically, during the inputting process, the user must perform four times of waiting operations while operating the keys 25 times. Therefore, the number of times that conventional character input systems complete the corresponding completion character increases from 25 to 29, considering the number of waiting steps as that of key operations.

As an another example, if a string ‘fffuuu’ is input, the input system and method according to an embodiment of the present invention allows the user to operate the keys 8 times in total as follows ‘3->C->C->C->8->B->B->B’. Conversely, conventional systems allow users to operate the keys 15 times in total for as follows ‘3->3>3->wait->3->3>3->wait->3->3>3->8->8->wait->8->8->wait->8->8’. Specifically, during the inputting process, the user must perform four times of waiting operations, while operating the keys 15 times. Therefore, the number of times that conventional character input systems complete the corresponding completion character increases from 15 to 19, considering the number of waiting steps as that of key operations.

As described above, the character input system and method according to the present invention reduces the number of times that a user inputs characters and support a rapid character input function without the waiting operation when successively inputting characters. Specifically, the character input system and method according to the present invention is advantageous in that, if a word is formed with characters that are located at the lower order of characters in group allocated to the keys and if a word is formed with characters that are repeated with the same characters, the number of times to input characters and the period of time to input characters is reduced.

Although the shortcut key zone 530 of the remote control device 100 includes four shortcut keys, A, B, C, and D, alternatively, the number of shortcut keys may be set according to how to allocate and arrange characters to keys of the character input region 500 of the remote control device 100. For example, if the respective keys in the character key zone 510 are allocated with three characters, as the maximum number of characters, the number of shortcut keys in the shortcut key zone 530 is three. Likewise, if the respective keys in the character key zone 510 are allocated with five characters, as the maximum number of characters, the number of shortcut keys in the shortcut key zone 530 is also five.

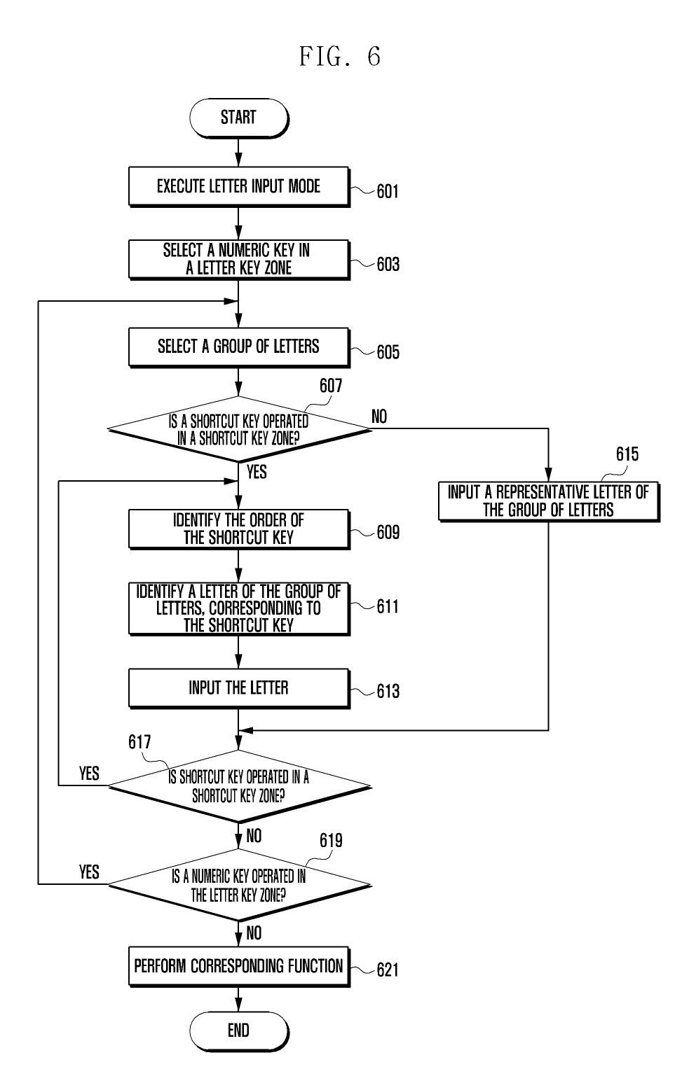

FIG. 6 is a flow chart for a method for inputting characters via a remote control device 100 according to an embodiment of the present invention.

Referring to FIG. 6, the remote control device 100 executes a character input mode in Step 601. That is, if the user selects a key corresponding to a character input mode in the remote control device 100, the remote control device 100 transmits the mode control signal for activating a character input mode to the display device 200. The display device 200 activates a character input mode according to the received mode control signal and displays a character input interface 300 and a character display field 400 on the screen that is currently activated.

The remote control device 100 detects a user's input to select a numeric key in the character key zone 510 in Step 603. The remote control device 100 detects the characters allocated to the selected numeric key as one group of characters in Step 605. The remote control device 100 may identify respective characters in the detected group of characters and a representative character of the detected group of characters and temporarily store them. The representative character refers to the character at the first order in the group of characters.

The remote control device 100 determines whether the user selects a shortcut key in the shortcut key zone 530 in Step 607.

If the remote control device 100 ascertains that the user did not select a shortcut key in the shortcut key zone 530 in Step 607, it inputs the representative character in the selected group of characters in Step 615. The remote control device 100 determines to input the representative character in the selected group of characters and transmits the corresponding character input signal to the display device 200. The display device 200 displays the representative character according to the received character input signal on the character display field 400. Next, the remote control device 100 proceeds with Step 617 described below.

If the remote control device 100 ascertains that the user selects a shortcut key in the shortcut key zone 530 in Step 607, it identifies the order of the selected shortcut key in arrangement in Step 609. The remote control device 100 identifies a character in the selected group of characters corresponding to the order of shortcut key in Step 611.

The remote control device 100 inputs the identified character in Step 613. The remote control device 100 determines a character, in the selected group of characters corresponding to the order of shortcut key, as a character to be input, and transmits the input signal corresponding to the identified character to the display device 200. The display device 200 displays the character according to the received character input signal on the character display field 400.

Next, the remote control device 100 determines whether the user selects a shortcut key in the shortcut key zone 530 in Step 617.

If the remote control device 100 ascertains that the user selects a shortcut key in the shortcut key zone 530 in Step 617, it returns to and proceeds with Step 609. Conversely, if the remote control device 100 determines that the user did not select a shortcut key in the shortcut key zone 530 in Step 617, it determines whether the user selects a key in the character key zone 510 in Step 619. If the remote control device 100 ascertains that the user selects a key in the character key zone 510 in Step 619, it returns to and proceeds with Step 605.

Conversely, if the remote control device 100 determines that the user did not select a key in the character key zone 510 in Step 619, it performs a corresponding function in Step 621. For example, the remote control device 100 may terminate the character input mode and controls the functions of the display device 200, according to a user's inputs.

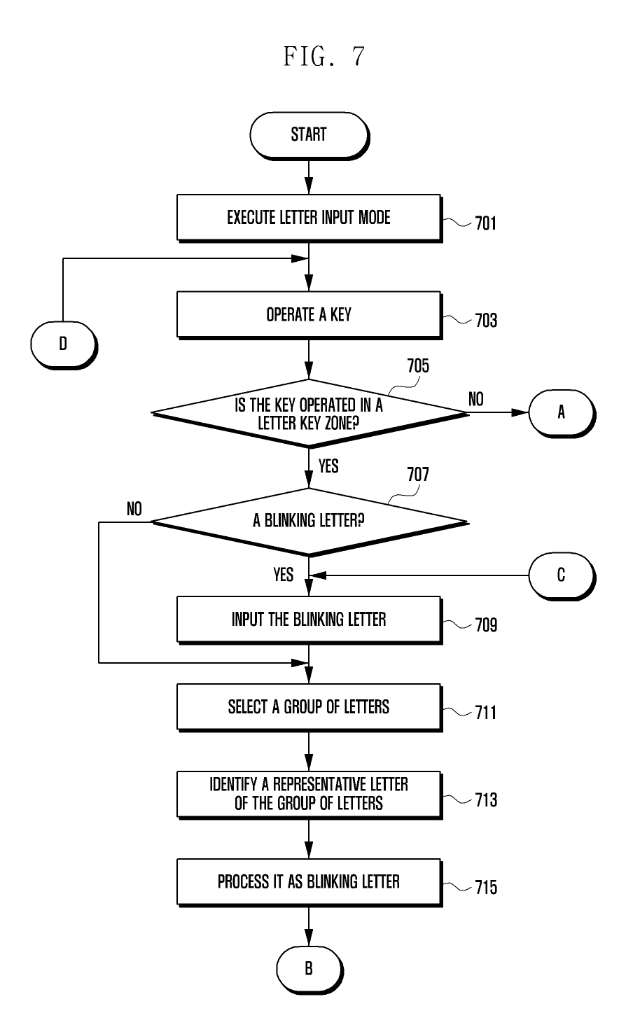

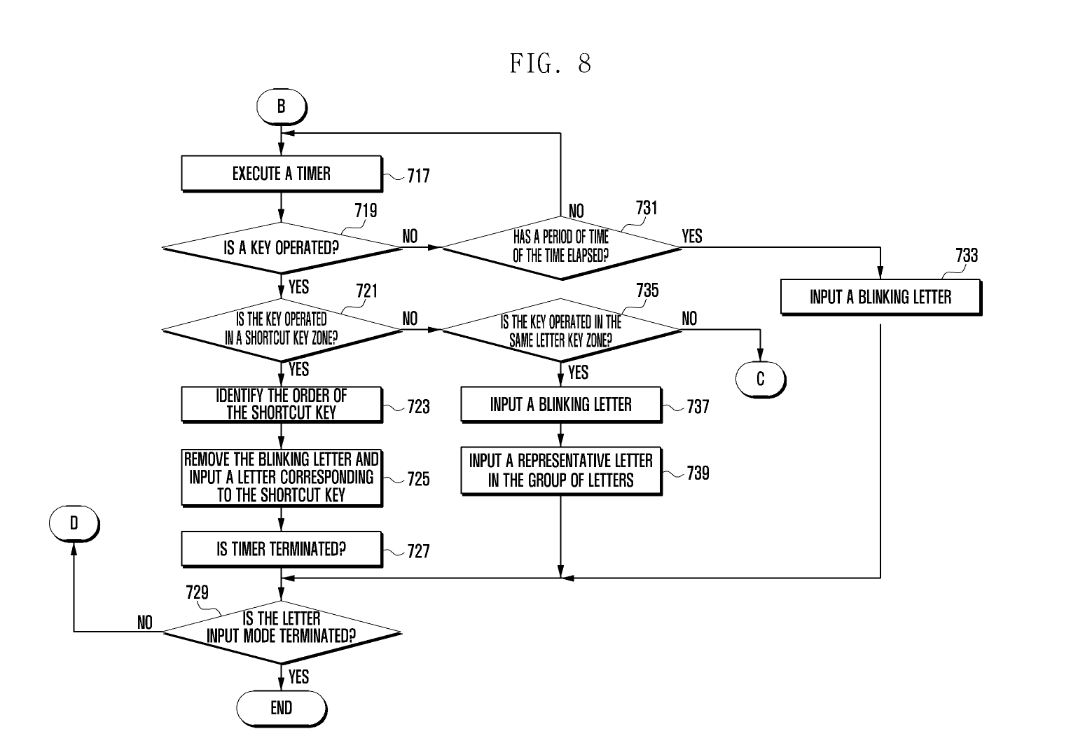

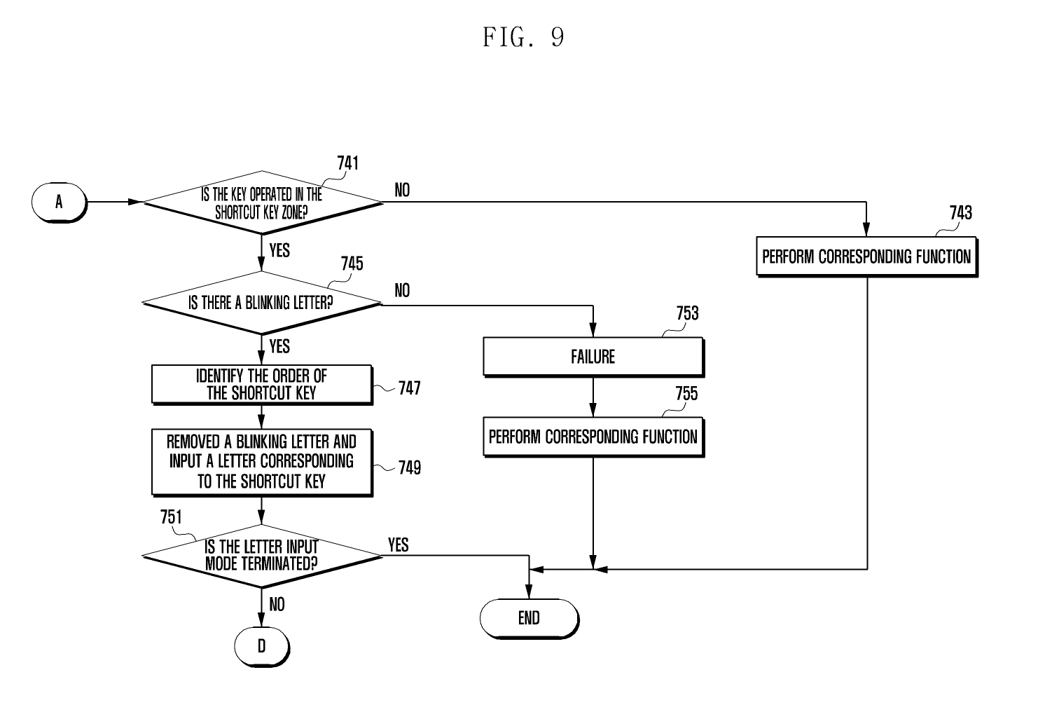

FIGS. 7 to 9 are flow charts for a method for controlling a remote control device 100 to perform a character input process. In FIGS. 7 to 9, process Steps A through D indicate a start to a respective subroutine, where Step A signals a subroutine starting with Step 714 in FIG. 9, Step B signals a subroutine starting with Step 717 in FIG. 8, Step C signals a subroutine starting with Step 709 in FIG. 7 and D signals a subroutine starting with Step 703 in FIG. 7.

Referring to FIG. 7, the remote control device 100 executes a character input mode in Step 701. That is, if the user selects a key corresponding to a character input mode in the remote control device 100, the remote control device 100 transmits the mode control signal for activating a character input mode to the display device 200. The display device 200 activates a character input mode according to the received mode control signal and displays a character input interface 300 and a character display field 400 on the screen that is currently activated.

The remote control device 100 detects a user's input to select a key in the character input mode in Step 703. Next, the remote control device 100 determines whether the user's input key is one of the keys in the character key zone 510 in Step 705. If the remote control device 100 determines that the user input does not correspond to one of the keys in the character key zone 510 in Step 705, it determines whether the user's input key is one of the shortcut keys in the shortcut key zone 530 in Step 741 described below referring to FIG. 9.

Conversely, if the remote control device 100 ascertains that the user's input key is one of the keys in the character key zone 510 in Step 705, it identifies whether there is a blinking character in Step 707. According to an embodiment of the present invention, the blinking character refers to a character, from among the group of characters allocated to a numeric key that has been selected in the character key zone 510, which is in a state before it is used to form a completion character. Displaying the blinking character may be executed or skipped depending on the settings. According to an embodiment of the present invention, the blinking character may be processed as a representative character in a group of characters.

If the remote control device 100 ascertains that there is a blinking character in Step 707, it inputs it in Step 709. Next, the remote control device 100 selects the characters, allocated to the selected numeric key, as one group of characters in Step 711. Conversely, if the remote control device 100 determines that a blinking character is not displayed in Step 707, it proceeds with Step 711.

Next, the remote control device 100 identifies a representative character in the selected group of characters in Step 713, and processes it as a blinking character in Step 715. Next, the remote control device 100 counts the number of clocks via a timer in Step 717 as illustrated in FIG. 8. For example, if the user selects a numeric key ‘6’, the remote control device 100 detects the characters ‘m’, ‘n’, and ‘o’ allocated to the key as a group of characters, and determines the character ‘m’ at the first order as a representative character. The remote control device 100 processes the representative character ‘m’ as a blinking character. Next, the remote control device 100 manages the blinking character ‘m’ without displaying it on the character display field 400 or with displaying it on the character display field 400, depending on the settings. If the following key is operated in the character key zone 510, or the character ‘m’ is input to the character display field 400 when a preset period of time of a timer has elapsed, or the following key is operated in the character shortcut key zone 530, the blinking character is altered to a character included in the group of characters (e.g., ‘m’->‘o’) corresponding to the order of the shortcut key.

After performing a clock counting operation in Step 717, the remote control device 100 determines whether the user operates a key in Step 719. If the remote control device 100 determines that the user did not operate a key in Step 719, it determines whether a preset period of time has elapsed in Step 731. If the remote control device 100 ascertains that a preset period of time has not elapsed in Step 731, it returns to and proceeds with step 717. Conversely, if the remote control device 100 ascertains that a preset period of time has elapsed in Step 731, it inputs the blinking character in Step 733, and then proceeds with step 729, as described below.

If the remote control device 100 ascertains that the user operates a key in Step 719, it determines whether the input key is one of the shortcut keys in the shortcut key zone 530 in Step 721. If the controller 150 determines that the input does not correspond to one of the shortcut keys in the shortcut key zone 530 in Step 721, it determines whether the input key is the previously selected, same key in the character key zone 510 in Step 735.

If the controller 150 ascertains that the input key is one of the shortcut keys in the shortcut key zone 530 in Step 721, it identifies the order of the input shortcut key in the shortcut key zone 530 in Step 723. Next, the remote control device 100 removes the blinking character and inputs the character corresponding to the shortcut key in Step 725. That is, the remote control device 100 alters the blinking character to a character included in the group of characters, corresponding to the order of the shortcut key, and then inputs it. For example, the remote control device 100 alters the blinking character ‘m’ in the character key zone 510 to a character ‘o’ in the group corresponding to the order of the shortcut key in the shortcut key zone 530 and then inputs it. After inputting the character in Step 725, the remote control device 100 stops the timer for counting the number of clocks for the blinking character in Step 727.

Next, the remote control device 100 determines whether a request is made to terminate the character input mode in Step 729. If the remote control device 100 ascertains that a request is not made to terminate the character input mode in Step 729, it returns to and proceeds with step 703 as illustrated in FIG. 7. If the remote control device 100 ascertains that a request is made to terminate the character input mode in Step 729, it terminates the mode.

Referring back to step 735, if the remote control device 100 ascertains that the input key is a new numeric key, not the previously selected, same key in the character key zone 510, it returns to and proceeds with step 709 as illustrated in FIG. 7.

Conversely, if the remote control device 100 ascertains that the input key is the previously selected, same numeric key in the character key zone 510 in Step 735, it inputs the blinking character in Step 737. Next, the remote control device 100 inputs the representative character in the group of characters allocated to the numeric key according to the user's key operation in Step 739. For example, while the remote control device 100 processes the character ‘w’ as a blinking character according to the user's operation to the numeric key ‘9’, if the user successively operates the numeric key ‘9’, the remote control device 100 inputs the blinking character ‘w’ and additionally inputs the character ‘w’ according to the user's successive operation to the key ‘9’, thereby inputting the string ‘ww’. After inputting the same character successively, the remote control device 100 proceeds with step 727.

Referring back to Step 705 as illustrated in FIG. 7, if the remote control device 100 determines that the user input does not correspond to a key in the character key zone 510 in Step 705 and determines whether it is one of the shortcut keys in the shortcut key zone 530 in Step 741 as illustrated in FIG. 9. If the remote control device 100 determines that the user input does not correspond to one of the shortcut keys in the shortcut key zone 530 in Step 741, it performs a corresponding function in Step 743. For example, the remote control device 100 controls the functions of the display device 200 according to the operations of the keys in the instruction input region 600.

Conversely, if the remote control device 100 ascertains that the user's input key is one of the shortcut keys in the shortcut key zone 530 in Step 741, it determines whether there is a blinking character in Step 745.

If the remote control device 100 ascertains that there is a blinking character in Step 745, it identifies the order of the input shortcut key in the shortcut key zone 530 in Step 747. Next, the remote control device 100 removes the blinking character and inputs the character corresponding to the shortcut key in Step 749. That is, the remote control device 100 alters the blinking character to a character included in the group of characters, corresponding to the order of the shortcut key, and then inputs it.

Next, the remote control device 100 determines whether a request is made to terminate the character input mode in Step 751. If the remote control device 100 ascertains that a request is not made to terminate the character input mode in Step 751, it returns to and proceeds with step 703 as illustrated in FIG. 7. If the remote control device 100 ascertains that a request is made to terminate the character input mode in Step 751, it terminates the mode.

If the remote control device 100 ascertains that there is no blinking character in Step 745, it concludes that the user's key input fails in Step 753, and performs the corresponding function in Step 755. For example, if a user's first input is made in the shortcut key zone 530 in a character input mode, the remote control device 100 concludes that the input has failed. In that case, the remote control device 100 does not respond to the failure or displays the message informing that the key input has failed on the display device 200.

As described above, the character input system and method according to an embodiment of the present invention allows users to input instructions (e.g., characters) to the display device via a remote control device in a simple procedure that reduces the character input time period. When users input instructions to a display device via a remote control device, the number of times to input characters is reduced which also eliminates a wait time when one of a number of characters allocated to one key is successively input. That is, when one of a number of characters allocated to one key is repeatedly input, the number of times that the users input the character is reduced and thus the time to input characters is reduced overall.

Because characters grouped and allocated to keys in the lower order of characters are frequently input and the same character is successively input, the character input system and method according to an embodiment of the present invention allows users to rapidly input the characters, irrespective of the order of characters or the repeated characters, compared with conventional character input systems. When the lowest order of character in a group of characters allocated to one key is input, the input system and method according to an embodiment of the present invention allows users to directly input the character. Conversely, conventional character input systems require users to operate the keys parsing from the character at the highest order in the group to the corresponding character, one by one. Therefore, the character input system and method according to the present invention reduces the number of times that the users input characters and provides user convenience.

When users input characters to a display device via a remote control device, the character input system and method according to the present invention can display user usage regarding the remote control device on the display device, and, can also display, if users operate the remote control device, the operation result in real time thereon. Therefore, the character input system and method according to the present invention allows users to precisely and easily input characters in an environment where the input unit is separated from the display.

The character input function according to the present invention can be applied to all types of display devices and the corresponding input devices. Specifically, the character input system and method according to the present invention can implement an optimal environment to support a character input function of a device with restricted space to allocate keys. Therefore, the character input system and method according to the present invention can support a more efficient and simple character input function when inputting characters via a remote control device, thereby enhancing user convenience and product competitiveness for the remote control device and the display device.

As described above, the embodiments according to the present invention can be implemented with program commands that can be conducted via various types of computers and recorded in computer-readable recording media. The computer-readable recording media contain program commands, data files, data structures, or the like, or a combination thereof. The program commands recorded in the recording media may be designed or configured to execute the method according to the present invention or may be implemented as software.

The computer-readable recoding media includes hardware systems for storing and conducting program commands. Examples of the hardware systems are magnetic media such as a hard disk, a floppy disk, a magnetic tape, optical media such as CD-ROM and DVD, Magneto-Optical Media, such as a floptical disk, ROM, RAM, flash memory, etc. The program commands include assembly language or machine code complied by a complier and a higher level language interpreted by an interpreter. The hardware systems may be implemented with at least one software module to comply with the present invention.

Although various embodiments of the present invention have been described in detail herein, it will be apparent to those of ordinary skill in the art that variations and modifications in form and detail may be made without departing from the spirit and scope of the invention as defined by the appended claims.

What is claimed is:

1. A character input method for inputting characters via a remote control device, comprising:
operating, by a user, a numeric key in a character key zone;
selecting a group of characters allocated to the operated numeric key;
operating a shortcut key in a shortcut key zone; and
inputting a character included in the group of characters, corresponding to the shortcut key.

2. The method of claim 1, wherein selecting the group of characters comprises:
inputting a representative character from the group of characters, corresponding to the numeric key.

3. The method of claim 2, further comprising:
inputting, when the numeric key operated in the character key zone is the same as a preceding numeric key, the representative character from the group, immediately after the preceding character.

4. The method of claim 2, wherein inputting the character included in the group of characters comprises:
replacing the representative character with a character from the group of characters, corresponding to an order of the shortcut key; and
inputting the corresponding character.

5. The method of claim 2, further comprising:
inputting a next character, when a shortcut key in the shortcut key zone is successively operated within a predetermined period of time after the group of characters has been selected, wherein the next character includes a character from the group of characters, corresponding to the operated shortcut key.

6. The method of claim 1, further comprising:
processing, when the group of characters is selected, a representative character from among the group of characters as a blinking character;
operating the numeric key in the character key zone; and
inputting, if the numeric key corresponds to a numeric key allocated with the group of characters, the blinking character, and
successively inputting the representative character of the group of characters.

7. The method of claim 6, further comprising:
inputting, if the numeric key corresponds to a numeric key allocated with another group of characters, the blinking character, and processing a representative character in another group of characters as a blinking character.

8. The method of claim 6, further comprising:
processing, if the group of characters is selected, a representative character from the group of characters as a blinking character;
operating a shortcut key in the shortcut key zone; and
replacing the blinking character with a character from the group of characters corresponding to the operated shortcut key; and
inputting the replaced character.

9. The method of claim 8, wherein processing the representative character as a blinking character comprises:
temporarily inputting and displaying the blinking character.

10. The method of claim 1, further comprising:
operating a key for executing a character input mode; and
transmitting a mode control signal for executing the character input mode to a display device.

11. The method of claim 10, further comprising:
displaying a character input interface and a character display field on the screen of the display device according to the mode control signal.

12. A character input system comprising:
a remote control device for creating instructions according to a user inputs, and for inputting characters via numeric keys in a character key zone and shortcut keys in a shortcut key zone, corresponding the numeric keys with the shortcut keys; and
a display device for displaying screens and character input states according to the control of the remote control device.

13. The character input system of claim 12, wherein the remote control device detects an operation of a numeric key in a character key zone, selects a group of characters allocated to the operated numeric key, detects an operation of a shortcut key in a shortcut key zone, and transmits a user instruction, for inputting a character included in the group of characters, corresponding to the shortcut key, to the display device.

14. The character input system of claim 13, wherein a number of shortcut keys in the shortcut key zone corresponds to the maximum number of characters allocated to a numeric key in the character key zone.

15. The character input system of claim 13, wherein the remote control device processes a representative character from the group of characters as a blinking character, and when a numeric key is operated in the character key zone, transmits an instruction for inputting the blinking character to the display device and when a shortcut key is operated in the shortcut key zone, transmits an instruction for replacing the blinking character to a character included in the group of characters corresponding to the operated shortcut key and inputting the altered character, to the display device.

16. The character input system of claim 12, wherein the display device displays a character input interface and a character display field on the screen according to the mode control signal from the remote control device.

17. The character input system of claim 16, wherein the character input interface displays a screen interface corresponding to the character input components of the remote control device and the character input interface is displayed and superimposed on the screen or displayed on one of a plurality of divided areas of the screen.

18. The character input system of claim 12, wherein the remote control device and the display device are synchronized with each other in a character input mode, and display information regarding instructions from the remote control device on a character input interface and a character display field.

19. The character input system of claim 18, wherein the character input interface displays feedback of a key operated in the remote control device and the character display field displays a character corresponding to the operated key of the remote control device.

20. A computer readable medium configured to store a program that transmits, to a display device, instructions for performing a user input method, the method comprising:
selecting, when a numeric key is operated in a character key zone of a remote control device, a predetermined group of characters corresponding to the numeric key; and
inputting, when a shortcut key is operated in a shortcut key zone of the remote control device, a character included in the group of characters corresponding to the operated shortcut key.
